(19) United States
(12) Patent Application Publication
(10) Pub. No.: US 2015/0281609 A1
(43) Pub. Date: Oct. 1, 2015

(54) Device for Acquiring an Image of a Sample, Comprising a Facility for Regulating the Heating of a Support for Receiving the Sample, and Associated Imaging System

(71) Applicant: Commissariat à l'énergie atomique et aux énergies alternatives, Paris (FR)

(72) Inventors: Vincent Poher, Guines (FR); Patrick Pouteau, Meylan (FR)

(21) Appl. No.: 14/439,197

(22) PCT Filed: Oct. 30, 2013
(86) PCT No.: PCT/EP2013/072720

§ 371 Date: Apr. 28, 2015

(30) Foreign Application Priority Data
Oct. 30, 2012 (FR) 12 60385

(51) Int. Cl. H04N 5/369; H04N 17/00

(52) U.S. Cl. CPC H04N 5/3698; H04N 17/002

(57) ABSTRACT

This acquisition device for acquiring an image of a sample comprises:
a receiving support for receiving the sample, the receiving support having a transparent surface, and
an image sensor, configured for acquiring an image of the sample, the image sensor being disposed in front of said transparent surface.

The acquisition device furthermore comprises a heating module for heating the receiving support, a temperature sensor configured for measuring a temperature of the receiving support and a regulating unit for regulating the heating of the receiving support, based on the temperature measured by the temperature sensor.

### BACKGROUND OF THE INVENTION

The present invention relates to an acquisition device for acquiring an image of a sample, the acquisition device comprising a receiving support for receiving the sample, the receiving support having a transparent surface, and an image sensor configured for acquiring an image of the sample, the image sensor being disposed in front of said transparent surface.

The invention also relates to an imaging system comprising such an acquisition device for acquiring an image of the sample and a source of spatially coherent light, configured for illuminating the sample along a direction of illumination.

The invention concerns in particular the reconstruction of a sample having diffracting objects immersed in a liquid medium contained in the support, with the support having a transparent surface and the diffracting objects being for example in contact with the transparent surface of the support.

The term optical properties is used to refer in particular to the absorption by the object or the phase delay introduced by the object, given that these parameters represent respectively the modulus and the argument of the complex opacity function of the object. The invention provides the ability in particular to determine the spatial distribution of these parameters.

The invention relates in particular to lensless imaging, also known as contact imaging, that is to say the acquisition, by the matrix photodetector, of images formed by the radiation transmitted directly by the sample, in the absence of a magnifying optical element disposed between the sample and the image sensor. The image sensor is also known in this case as lensless imaging device, and is configured for forming an image of the sample while being located at a small distance from the latter. The term small distance, is used to refer to a distance of between 100 μm (microns) and a few centimetres, preferably less than 1 cm.

From the document EP 2233923 A1 an acquisition device of the aforementioned type is known. This document describes a system that provides the ability to characterise the dynamics of coagulation or sedimentation of a fluid containing blood. The characterisation system includes in particular an acquisition device for acquiring an image of the fluid, and a spatially coherent light source configured for illuminating the fluid. The acquisition device comprises a fluid chamber into which the fluid containing blood particles is introduced, with the fluid chamber forming a support for receiving the sample to be characterised. The fluid chamber is at ambient temperature.

The acquisition device also includes an image sensor, such as a matrix sensor of such type as CCD (abbreviation for the English term Charged-Coupled Device) or CMOS (abbreviation for the English term Complementary Metal Oxyde Semi-conductor), arranged so as to enable the acquisition of a temporal series of images of an optical granularity pattern created by the interaction between the particles contained in the chamber and a light beam coming from the light source.

However, controlling of the ambient temperature does not provide for the proper regulation of the temperature of the fluid chamber, which makes it difficult to carry out the imaging of certain particles, such as proteins.

### SUMMARY OF THE INVENTION

The object of the invention is therefore to provide an acquisition device that makes it possible to improve the regulation of the temperature of the receiving support and the sample in this support, in order to prevent degradation over the course of time of the properties of the sample to be observed.

To this end, the subject-matter of the invention relates to an acquisition device of the aforementioned type, wherein the device further comprises a heating module for heating the receiving support, a temperature sensor configured for measuring a temperature of the receiving support and a regulating unit for regulating the heating of the receiving support, based on the temperature measured by the temperature sensor.

According to other advantageous aspects of the invention, the acquisition device includes one or more of the following features, taken into consideration in isolation or in accordance with any technically possible combinations:
the regulating unit is configured for regulating the heating of the receiving support in function of a predetermined set point temperature, and the image sensor forms the heating module, the regulating unit being configured for controlling the powering up of the image sensor as long as the predetermined set point temperature has not been reached;
the heating module comprises at least one transparent layer disposed in contact with at least one surface of the receiving support;
the transparent layer is a silk screen print of said surface, such as an indium tin oxide silk-screen print;
the sample is adapted to be illuminated by a light beam along a direction of illumination, and the surface in contact with the transparent layer is substantially perpendicular to the direction of illumination;
the heating module includes an electrical heating resistor, and the sample is adapted to be illuminated by a light beam along a direction of illumination, with the image sensor being disposed between the receiving support and the heating resistor along the direction of illumination;
the heating resistor is a deposit of electrically conductive elements in contact with the image sensor; and
the sample is adapted to be illuminated by a light beam along a direction of illumination, and the distance between the receiving support and the image sensor along the direction of illumination is less than 1 cm.

The subject-matter of the invention also relates to an imaging system comprising an acquisition device for acquiring an image of the sample and a spatially coherent light source configured for illuminating the sample along a direction of illumination, wherein the acquisition device is as defined here above.

According to another advantageous aspect of the invention, the imaging system includes the following feature:
the receiving support is disposed between the light source and the image sensor along the direction of illumination.

### BRIEF DESCRIPTION OF THE DRAWINGS

The features and advantages of the invention will become apparent upon reading the description that follows, given purely by way of non-limiting example, and with reference being made to the accompanying drawings, in which:

FIG. 1 is a schematic representation of an imaging system according to the invention, comprising a light source configured for illuminating a sample and an acquisition device for acquiring an image of the sample;

FIG. 2 is a schematic representation of the acquisition device according to a first embodiment of the invention, the acquisition device comprising a receiving support for receiving the sample, an image sensor, the image sensor forming the heating module for heating the receiving support, a sensor for sensing the temperature of the receiving support and a regulating unit for regulating the heating of the receiving support;

FIG. 3 is a schematic representation of the regulating unit shown in FIG. 2, including a feedback loop;

FIG. 4 is a graphic view representing a curve of the temperature of the image sensor associated with a first timing chart relative to the powered up state of the image sensor;

FIG. 5 is a view that is analogous to that shown in FIG. 4 for a second timing chart relative to the powered up active state of the image sensor;

FIG. 6 is a view of a thermal image of the image sensor, prior to the powering on of the image sensor;

FIG. 7 is a graph of a curve representing the temperature of the image sensor along the segment VII shown in FIG. 6;

FIG. 8 is a view of a thermal image of the image sensor, after the powering on of the image sensor;

FIG. 9 is a graph of a curve representing the temperature of the image sensor along the segment IX shown in FIG. 8;

FIG. 10 is a view that is analogous to that shown in FIG. 2, according to a second embodiment of the invention; and

FIG. 11 is a view that is analogous to that shown in FIG. 2, according to a third embodiment of the invention.

### DETAILED DESCRIPTION OF PREFERRED EMBODIMENTS

In a conventional manner, in this present patent application, the term “substantially equal to” will express a relationship of equivalence to within more or less 5%.

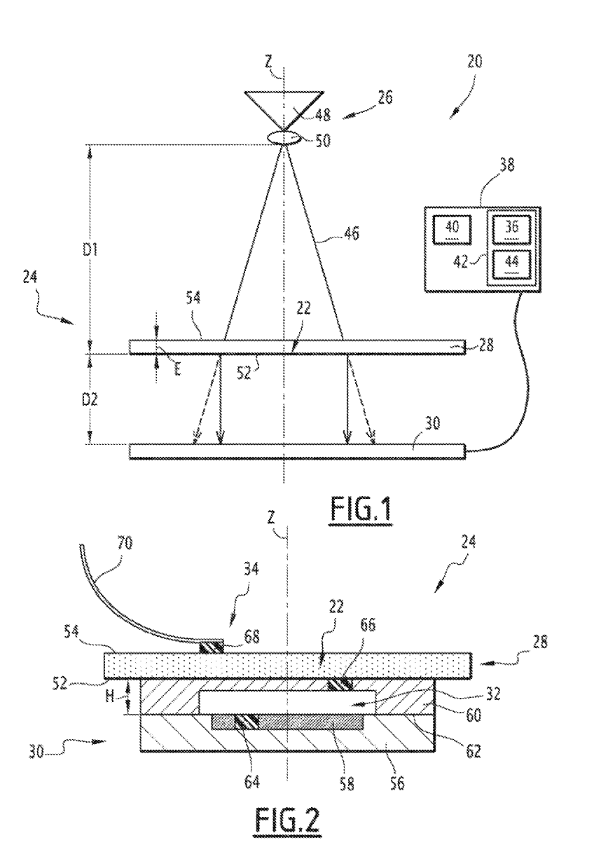

In FIG. 1, an imaging system 20 for imaging a sample 22 comprises an acquisition device 24 for acquiring an image of the sample 22 and a spatially coherent light source 26 configured for illuminating the sample 22 along a direction of illumination. The direction of illumination is, for example, the vertical direction Z.

The imaging system 20 is configured for establishing an image of said sample.

Based on the latter, the optical properties of the sample 22, in particular the absorption or phase delay, are, for example, reconstructed using a reconstruction software application.

The sample 22 has diffracting objects, not represented, the diffracting objects being, for example, particles, such as biological particles, that is to say various cells (for example, red blood cells, white blood cells or platelets), bacteria, or bacterial colonies, cells or cell aggregates. Alternatively, the diffracting particles are microbeads.

The acquisition device 24 comprises a support 28 for receiving the sample 22 and an image sensor 30, configured for acquiring an image of the sample 22. The receiving support 28 makes possible the containment of the sample 22 at a controlled distance from the acquisition device 24. It comprises a transparent surface, between the sample 22 and the image sensor 30. Thus, the image sensor 30 is configured for establishing an image of the sample 22.

The acquisition device 24 further comprises a heating module 32 for heating the receiving support 28 and a temperature sensor 34 configured for measuring a temperature of the receiving support 28, that are visible in FIG. 2. This heating module should not disrupt the path of the photons from the light source. Indeed, the analysis of the sample being based on the image of the sample acquired by the image sensor 30, it is necessary that the optical path between the sample 22 and the image sensor 30 be as little disturbed as is possible.

The acquisition device 24 further comprises a regulating unit 36 for regulating the heating of the receiving support 28, based on the temperature measured by the temperature sensor 34, as shown in FIG. 1.

According to one embodiment, the acquisition device 24 also comprises a data processing unit 38 having a processor 40 and a memory storage 42 that is configured for storing a software programme 44 for determining the properties of the sample 22, these properties being determined by the image sensor 30. The term properties, is used to refer to the optical properties of the sample (for example absorption), or the physical properties (coagulation, agglomeration of particles), or even the presence or absence of an analysing agent.

The acquisition device 24 includes a protective housing, not represented, within which are arranged in particular the receiving support 28, the image sensor 30, the heating module 32, the temperature sensor 34, the regulating unit 36 and the data processing unit 38.

The light source 26 is configured for emitting a light beam 46 along the vertical direction Z, in order to illuminate the sample 22. The light source 26 is disposed at a first distance D1 from the receiving support 28 along the direction of illumination Z. The first distance D1, preferably presents a value of between 1 cm and 30 cm.

The light source 26 is a spatially coherent source and includes, for example, a point source such as a light emitting diode 48, also known as LED (acronym from the English term Light Emitting Diode), and a diaphragm 50, disposed in contact with the LED 48. The diaphragm 50 has a diameter of between 50 μm and 500 μm, and is placed in contact with the LED 48. This makes it possible to increase the spatial coherence of the light radiation. When the light source 26 includes the LED 48, the first distance D1 is, for example, equal to 8 cm.

Alternatively, the light source 26 is constituted of the light emitting diode 48, and does not have a diaphragm. The light emitting diode 48 then presents dimensions that are sufficiently reduced so as to be considered especially coherent, the diameter of the light emitting diode being less than one tenth of the first distance D1 separating this light emitting diode from the receiving support 28.

Alternatively, the light source 26 is a spatially and temporally coherent light source, such as a laser diode (LD) or a laser diode of the VCSEL type (abbreviation for the English term Vertical Cavity Surface Emitting Laser). The laser diode has a wavelength that is for example substantially equal to 670 nm.

The receiving support 28 is disposed between the light source 26 and the image sensor 30 along the direction of illumination Z. It includes at least one plate 52, which is transparent and substantially perpendicular to the direction of illumination Z.

The receiving support 28 includes, for example, a bottom plate 52, which is transparent, and a top plate 54, which is translucent, and preferably transparent, substantially perpendicular to the vertical direction of illumination Z, as represented in FIGS. 1 and 2. These plates 52, 54 are transparent or translucent in order to allow for the illumination of the sample 22 by the light source 26, as well as the acquisition of images by the image sensor 30. The bottom plate 52 and top plate 54 are, for example, two glass slides, separated by spacers, not represented, in a manner such that the glass slides are spaced approximately 160 μm apart in the vertical direction Z.

The receiving support 28 has a thickness E along the vertical direction Z. The thickness E, for example, has a value of between 20 μm and 1000 μm, preferably comprised between 30 μm and 300 μm.

The receiving support 28 is disposed at a second distance D2 from the image sensor 30 along the direction of illumination Z. The second distance D2 then corresponds to the distance between the image sensor 30 and the bottom plate 52 in the vertical direction Z. The first distance D1 then corresponds to the distance between the light source 26 and the bottom plate 52 along the vertical direction Z.

The receiving support 28 is, for example, a fluid chamber intended for receiving the sample 22 in liquid form. The fluid chamber 28 comprises a deposition zone for depositing the liquid and one or more fluid circulation channels for circulation of the liquid 22, not represented, delimited by the bottom plate 52 and top plate 54 along the vertical direction of illumination Z.

The image sensor 30 is configured for acquiring images of the radiation transmitted by the sample 22 illuminated by the light beam 46. The term radiation transmitted, is used to refer to the radiation that passes through the sample 22 in a manner such that the image sensor 30 and the light source 26 are situated on either side of the sample 22. The image sensor 30 is disposed so as to be facing the transparent bottom plate 52.

The image sensor 30 is configured for establishing at least one diffraction pattern transmitted by the sample 22, each diffraction pattern corresponding to the waves diffracted by one or more particles, during the illumination of the sample 22.

The image sensor 30 includes a substrate 56, a matrix photodetector 58 incorporated into the substrate 56 and a protective cover 60 to protect the photodetector 58, with the protective cover 60 being disposed above the photodetector 58 and bearing against an upper peripheral edge 62 of the support.

In the example shown in FIG. 2, the image sensor 30 is a CMOS image sensor, and the photodetector 58 is a CMOS. Alternatively, the image sensor 30 is a CCD image sensor, and the photodetector 58 is a CCD.

The image sensor 30 is disposed at the second distance D2 from the receiving support 28 along the vertical direction Z. The second distance D2 has a value comprised between 100 μm and a few centimetres, preferably less than 1 cm, and more preferably between 100 μm and 2 mm. In the described example, the second distance D2 is substantially equal to 300 μm.

In the example shown in FIG. 2, the receiving support 28 is disposed to be bearing against the top surface of the protective cover 60, and the second distance D2 is then substantially equal to the height H of the protective cover 60 along the vertical direction Z.

The favouring of a second distance D2 having a low value, that is to say, a short distance between the image sensor 30 and the receiving support 28, makes it possible to limit the interference phenomena between the different diffraction patterns when the sample 22 is illuminated.

The images acquired by the image sensor 30 are formed by the radiation transmitted directly by the sample 22, in the absence of a magnifying optical element disposed between the receiving support 28 and the image sensor 30. The image sensor 30 is also known as lensless imaging device, and is configured for forming an image of the sample 22, while being placed at a small distance from the latter. The term small distance, is used to refer to, as indicated above, a distance of less than a few centimetres, preferably less than 1 cm, the second distance D2 being for example equal to 300 μm. The absence of the magnifying optical element mentioned above does not exclude the presence of micro lenses formed at the level of each pixel of the image sensor 30.

The heating module 32 is configured for heating the receiving support 28 after receiving a control command sent from the regulating unit 36, the regulating unit 36 being configured for controlling the heating of the image sensor 30 as long as a predetermined set point temperature Tset point has not been reached.

According to a first embodiment described, the heating module 32 is formed by the image sensor 30, the regulating unit 36 being configured for controlling the powering up of the image sensor 30 as long as a predetermined set point temperature Tset point has not been reached.

The temperature sensor 34 includes at least one temperature sensor 64, 66, 68 arranged in the proximity of the receiving support 28. In the example shown in FIG. 2, the temperature sensor 34 includes a first temperature probe 64 incorporated into the photodetector 58 of the image sensor. The temperature sensor 34 includes a second temperature probe 66 disposed on the top surface of the protective cover 60 and in contact with the bottom plate 52 of the receiving support. The temperature sensor 34 includes a third temperature probe 68 attached on to a retaining tab 70, the retaining tab 70 being configured for holding in place the receiving support 28 to be bearing against the protective cover 60. The first, second and third temperature probes 64, 66, 68 are known per se.

Alternatively, the temperature sensor 34 includes only one or two probes out of the first, second and third temperature probes 64, 66, 68.

The regulating unit 36 is configured for regulating the heating of the receiving support 28 based on the predetermined set point temperature Tset point.

The regulating unit 36 is created, for example, in the form of a software application, and the memory storage 42 is configured for storing the regulating software application 36. Alternatively, the regulating unit 36 is created in the form of a dedicated integrated circuit, or in the form of a programmable logic circuit.

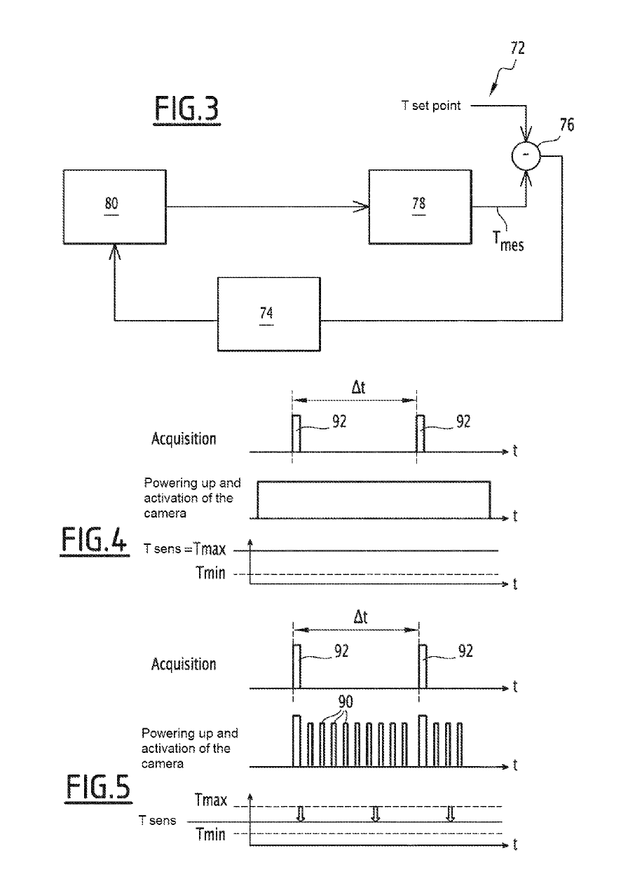

The regulating unit 36 includes, for example, a feedback loop 72, described subsequently here below with reference to FIG. 3.

The matrix photodetector 58 includes a plurality of pixels, not represented. Each pixel of the photodetector 58 has dimensions that are less than or equal to 10 μm, or even 4 μm. Each pixel is, for example, in the form of a square whose side has a value that is less than or equal to 10 μm, or even to 4 μm. Alternatively, each pixel is in the form of a square whose side measures 2.2 μm.

The matrix photodetector 58 is a sensor of images in two dimensions, that is to say in a plane perpendicular to the longitudinal axis X.

The matrix photodetector 58 includes in addition microlenses, not represented, with each microlens being disposed above a corresponding pixel. Such microlenses are incorporated into the sensor. They provide the ability to improve the light collection efficiency and do not constitute a magnification optical element disposed between the receiving support 28 and the photodetector 58.

The feedback loop 72, visible in FIG. 3, includes a calculation stage 74 for calculating a temperature correction, and a subtracter 76 connected to the input of the calculation stage 74, with the subtractor 76 receiving as input, on the one hand, the predetermined set point temperature Tset point, and on the other hand, an instantaneous temperature Tmes, the instantaneous temperature Tmes being measured by a measurement stage 78 for measuring the temperature of the receiving support.

The feedback loop 72 includes a heating control stage 80 for controlling the heating module 32 for a predetermined period of time based on the correction calculated, the control stage 80 being connected to the output of the calculation stage 74, and the measurement stage 78 being connected to the output of the heating control stage 80.

In the described embodiment, the control stage 80 is configured for controlling the powering up of the image sensor 30 for a predetermined period of time based on the correction calculated. The temperature of the image sensor 30, denoted as Tsens, then satisfies the following equation:

Tsens=Tmin+(Tmax−Tmin)×ρ (1)

with ρ=duration of powered up state/duration of cycle

where Tmin represents a minimum value for the temperature of the image sensor 30,

and Tmax represents a maximum value for the temperature of the image sensor 30.

When the image sensor 30 remains powered up and active on a continuous basis, the temperature of the image sensor Tsens is equal to the maximum value Tmax, as is represented in FIG. 4. When the image sensor 30 is not powered up and active on a continuous basis, with the image sensor 30 being supplied with power over successive voltage pulses 90, then the temperature of the image sensor Tsens is strictly comprised between the minimum value Tmin and the maximum value Tmax as shown in FIG. 5. The minimum value Tmin corresponding to the temperature of the image sensor 30 when the latter is powered off for a minimum period of time.

In the example shown in FIGS. 4 and 5, the images are acquired by the image sensor 30 at a rate of 2 images per second, and the time period Δt between two image acquisitions 92 is substantially equal to 500 ms. The time period of acquisition of the image is very short, in comparison with the time period Δt between two acquisitions, the acquisition time period being of the order of several ms, which allows for a regulated supply of power to the image sensor 30 between two image acquisitions 92, for example with the aid of pulses 90 as shown in FIG. 5.

On the basis of the equation (1) and the correction calculated by the calculation stage 74, the control stage 80 deduces therefrom the duration of the powered up state of the image sensor 30.

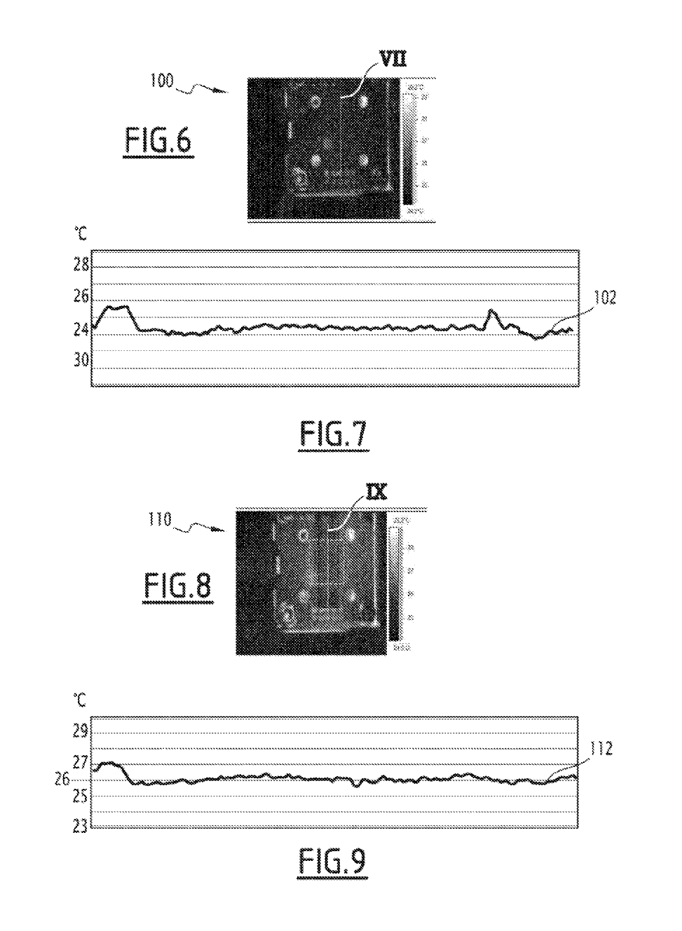

FIG. 6 shows a first thermal image 100 of the image sensor 30, prior to the powering up of the image sensor 30, and in FIG. 7, a first curve 102 represents the temperature of the image sensor Tsens, along the segment VII shown in FIG. 6. The first curve 102 shows that the minimum temperature Tmin is substantially equal to 24° C. in the described example of embodiment.

FIG. 8 represents a second thermal image 110 of the image sensor 30, after the regulated powering up of the image sensor 30, and in FIG. 9, a second curve 112 represents the temperature of the image sensor Tsens along the segment IX shown in FIG. 8. The second curve 112 shows that the temperature of the image sensor Tsens fluctuates substantially around 26° C. in the described example, the predetermined set point temperature Tset point being equal to 26° C. in this example.

Thus, by adjusting the time instants of powering up of the image sensor 30, the regulating unit 36 provides the ability to adjust the temperature of the image sensor Tsens based on the desired set point temperature Tset point. The image sensor 30 that forms the heating module 32, outside the periods of image acquisition, then provides the ability to heat the sample 22 contained in the receiving support 28 without affecting the transparency of the receiving support, in order to not disrupt the path of the photons of the light beam 46.

The heating module 32 formed by the image sensor 30 is furthermore particularly simple and inexpensive since it does not require any additional heating element.

In addition, the regulation of the heating of the receiving support 28 by making use of the feedback loop 72 is particularly simple to carry out.

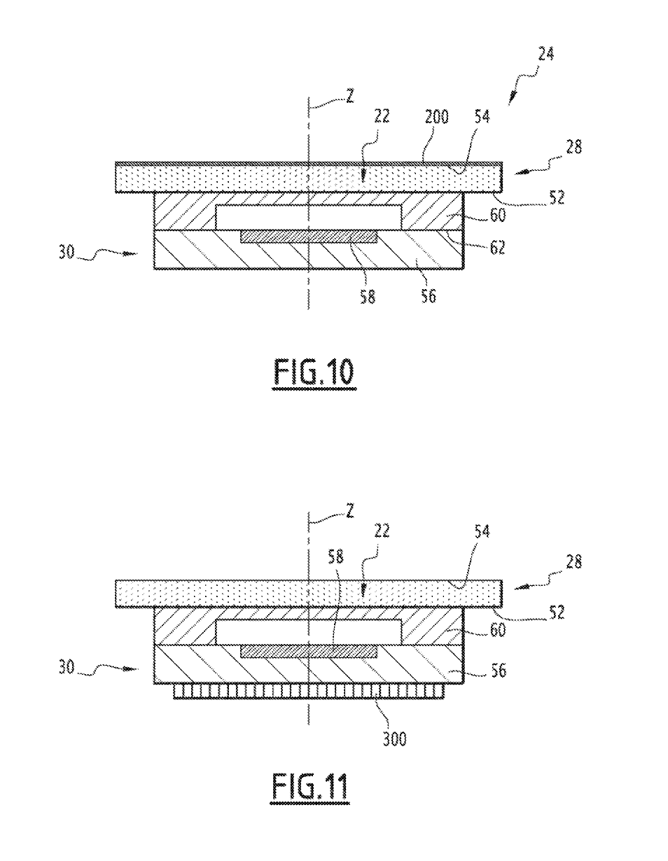

FIG. 10 illustrates a second embodiment for which the elements that are analogous to those in the first embodiment, previously described above, are identified by identical reference numerals, and have not been described again.

In FIG. 10, the one or more temperature sensors 64, 66, 68 have not been represented for the purposes of simplification of the drawings.

In the second embodiment, the heating module 32 includes a transparent layer 200 disposed in contact with a transparent surface of the receiving support 28.

The surface in contact with the transparent layer 200 is substantially perpendicular to the direction of illumination Z.

In the example shown in FIG. 10, the transparent layer 200 is disposed in contact with the top plate 54. Alternatively, not shown, the transparent layer 200 is disposed in contact with the bottom plate 52.

Alternatively, the transparent layer 200 is disposed in contact with the bottom plate 52 and also with the top plate 54. The heating module 32 then comprises two transparent layers 200 disposed in contact respectively with the bottom and top surfaces of the receiving support 28.

The one or more transparent layers 200 are capable, when they are electrically powered up, of heating the surface or surfaces of the receiving support 28 in contact with which they are disposed, while retaining their transparency.

The transparent layer 200 comprises, for example, of an electrical resistor created using a transparent conductive material. Such a circuit is formed on said surface 52, by means of a known method, for example a silk-screen printing process. It is in particular made out of a material such as indium tin oxide, also known as ITO (abbreviation of the English term Indium Tin Oxide).

The one or more transparent layers 200 present a refractive index having a value that is close to that of the refractive index associated with the surface of the receiving support 28 that is in contact with the transparent layer or layers 200. The term ‘value close to’ is used to indicate a value equal, for example, to within more or less 20% of that of the refractive index associated said surface of the receiving support 28.

The refractive index of the indium tin oxide is, for example, substantially equal to 1.7 for a wavelength of 633 nm, the value of the refractive index being, at the same wavelength, substantially equal to 1.5 for plexiglass and 1.55 for glass.

The heating module 32 formed by the one or more transparent layers 200 then makes it possible to heat the sample 22 contained in the receiving support 28 without affecting the transparency of the receiving support 28, so as not to disrupt the path of the photons of the light beam 46.

Preferably, the transparent layer 200 is formed on the top plate 54 of the receiving support 28. Indeed, it is preferable to limit the number of materials between the sample 22 and the optical sensor 58.

The heating module 32 formed by the transparent layer or layers 200 is furthermore particularly simple and inexpensive.

In addition, the regulation of the heating of the receiving support 28 by making use of the feedback loop 72 is also quite simple to implement with the one or more transparent layers 200.

The second embodiment constitutes a separate aspect of the invention that is distinct from that of the first embodiment. The person skilled in the art will quite certainly understand that the heating module 32 may possibly include both the control stage 80 for controlling the powering up of the image sensor as long as the predetermined set point temperature Tset point has not been reached according to the first embodiment, as well as the one or more transparent layers 200 according to the second embodiment.

FIG. 11 illustrates a third embodiment for which the elements that are analogous to those in the first embodiment, previously described above, are identified by identical reference numerals, and have not been described again.

In FIG. 11, the one or more temperature sensors 64, 66, 68 have not been represented for the purposes of simplification of the drawings.

According to the third embodiment, the heating module 32 comprises of a heating element 300, such as an electrical resistor. The heating resistor 300 is disposed to be in contact with the bottom surface of the image sensor 30 along the vertical direction Z. In the example shown in FIG. 11, the heating resistor 300 is disposed to be in contact with the bottom surface of the substrate 56. In other words, the image sensor 30 is disposed between the receiving support 28 and the heating resistor 300 along the direction of illumination Z. The image sensor 30 is thermally conductive, and is thus configured for conducting the heat released by the heating resistor 300, when it is electrically powered up, to the receiving support 28.

The heating resistor 300 is, for example, in the form of a deposit of electrically conductive elements in contact with the image sensor 30, for example in contact with the bottom surface of the substrate 56.

The heating module 32 formed by the heating resistor 300 then makes it possible to heat the sample 22 contained in the receiving support 28 without disrupting the path of the photons of the light beam 46 from the light source 26 to the image sensor 30, the heating resistor 300 being disposed on the other side of the image sensor 30 relative to the light source 26.

The heating module 32 formed by the heating resistor 300 is in addition simple and inexpensive to implement in operation.

In addition, the regulation of the heating of the receiving support 28 by making use of the feedback loop 72 is also simple to implement operationally with the heating resistor 300.

The third embodiment constitutes a separate aspect of the invention that is distinct from that of the first embodiment or even the second embodiment. The person skilled in the art will quite certainly understand that the heating module 32 may possibly include both the control stage 80 for controlling the powering up of the image sensor as long as the predetermined set point temperature Tset point has not been reached according to the first embodiment, the one or more transparent layers 200 according to the second embodiment, as well as the heating resistor 300 according to the third embodiment.

Of course, the heating module 32 is also likely to include both the one or more transparent layers 200 according to the second embodiment, as well as the heating resistor 300 according to the third embodiment.

According to a fourth embodiment, the heating module 32 comprises of a heating element 300, such as an electrical resistor. The heating resistor 300 is disposed to be in contact with the receiving support 28. This electrical resistor is preferably situated outside the field of view of the image sensor 30, or at the limit of the latter, in a manner such that its effect on the image of the sample 22 is negligible. When the electrical resistor is situated within the field of view of the image sensor 30, it delimits a region of interest for the image that is used for the processing performed by the data processing unit 38. In other words, these processing operations are performed on a portion of the image that is not influenced by the electrical resistor.

According to this embodiment, the receiving support 28 comprises a thermally conductive material, that makes it possible to conduct the heat generated by the sample 22. This conductive material is, for example, ITO or a transparent ceramic, for example based on AlN (Aluminum Nitride).

The heating module 32 formed by the heating resistor 300 then makes it possible to heat the sample 22 contained in the receiving support 28 without disrupting the path of the photons of the light beam 46 from the light source 26 to the image sensor 30, the heating resistor 300 being disposed outside the field of view of said sensor, or on the periphery of the latter.

The heating module 32 formed by the heating resistor 300 is in addition simple and inexpensive to implement in operation.

In addition, the regulation of the heating of the receiving support 28 by making use of the feedback loop 72 is also simple to implement operationally with the heating resistor 300.

The fourth embodiment constitutes a separate aspect of the invention that is distinct from that of the embodiments previously described. The person skilled in the art will quite certainly understand that the heating module 32 may possibly include both the control stage 80 for controlling the powering up of the image sensor as long as the predetermined set point temperature Tset point has not been reached according to the first embodiment, the one or more transparent layers 200 according to the second embodiment, as well as the heating resistor 300 according to the third or fourth embodiment.

Of course, the heating module 32 is also likely to include both the one or more transparent layers 200 according to the second embodiment, as well as the heating resistor 300 according to the third and/or fourth embodiments.

It is thus understood that the acquisition device 24 according to the invention makes it possible to improve the temperature regulation of the receiving support 28 and the sample 22 contained in this support 28 in order to prevent the degradation over time of properties of the sample to be observed 22.

1. An acquisition device for acquiring an image of a sample, the acquisition device comprising:
a receiving support for receiving the sample, the receiving support having a transparent surface; and
an image sensor, configured for acquiring an image of the sample, the image sensor being disposed in front of said transparent surface;
wherein the device further comprises a heating module for heating the receiving support, a temperature sensor configured for measuring a temperature of the receiving support and a regulating unit for regulating the heating of the receiving support, based on the temperature measured by the temperature sensor.

2. The device according to claim 1, wherein the regulating unit configured for regulating the heating of the receiving support in function of a predetermined set point temperature, and the image sensor forms the heating module, the regulating unit being configured for controlling the powering up of the image sensor as long as the predetermined set point temperature has not been reached.

3. The device according to claim 1, wherein the heating module comprises at least one transparent layer disposed in contact with at least one surface of the receiving support.

4. The device according to claim 3, wherein the transparent layer is a screen print of said surface, such as an indium tin oxide silk-screen print.

5. The device according to claim 3, wherein the sample is adapted to be illuminated by a light beam along a direction of illumination, and the surface in contact with the transparent layer is substantially perpendicular to the direction of illumination.

6. The device according to claim 1, wherein the heating module includes an electrical heating resistor, and wherein the sample is adapted to be illuminated by a light beam along a direction of illumination, the image sensor being disposed between the receiving support and the heating resistor along the direction of illumination.

7. The device according to claim 6, wherein the heating resistor is a deposit of electrically conductive elements in contact with the image sensor.

8. The device according to claim 1, wherein the sample is adapted to be illuminated by a light beam along a direction of illumination, and the distance between the receiving support and the image sensor along the direction of illumination is less than 1 cm.

9. An imaging system comprising an acquisition device for acquiring an image of a sample and a spatially coherent light source, configured for illuminating the sample along a direction of illumination, wherein the acquisition device is according to claim 1.

10. The system according to claim 9, wherein the receiving support is disposed between the light source and the image sensor along the direction of illumination.
